(19) United States
(12) Patent Application Publication
(10) Pub. No.: US 2006/0220996 A1
(43) Pub. Date: Oct. 5, 2006

(54) Plasma display panel and method of driving the same

(75) Inventors: Sang-Hun Jang, Suwon-si (KR); Hidekazu Hatanaka, Suwon-si (KR); Hyoung-Bin Park, Suwon-si (KR); Gi-Young Kim, Suwon-si (KR); Seung-Hyun Son, Suwon-si (KR); Sung-Soo Kim, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/390,277

(22) Filed: Mar. 28, 2006

(30) Foreign Application Priority Data
Mar. 29, 2005 (KR) 10-2005-0025977

(51) Int. Cl. G09G 3/28

(52) U.S. Cl. 345/63

(57) ABSTRACT

A plasma display panel (PDP) and a method of driving the same, and the PDP includes a lower substrate and an upper substrate facing each other with a discharge space therebetween, a plurality of barrier ribs arranged between the lower substrate and the upper substrate to partition the discharge space and define a plurality of discharge cells, a pair of first and second sustain electrodes corresponding to the discharge cells electron emission sources that correspond to the discharge cells, emit electrons into the discharge cells to address the discharge cells and simultaneously cause a sustain discharge between the first and second sustain electrodes, and a florescent layer coated on inner walls of the discharge cells.

### CROSS-REFERENCE TO RELATED APPLICATION

This application claims priority to and the benefit of Korean Patent Application No. 10-2005-0025977, filed on Mar. 29, 2005, which is hereby incorporated by reference for all purposes as if fully set forth herein.

### BACKGROUND OF THE INVENTION

1. Field of the Invention

The present invention relates to a plasma display panel (PDP), and more particularly, to a PDP including electron emission sources that have an addressing function, and a driving method of the PDP.

2. Discussion of the Background

Generally, a PDP displays an image by applying a voltage to electrodes to cause a gas discharge between the electrodes, thereby generating ultraviolet (UV) rays to excite a fluorescent material, which emits visible light. PDPs may be direct current (DC) PDPs or alternating current (AC) PDPs according to their discharge cell structure. All electrodes of a DC PDP are exposed to a discharge space, and charges move directly between the electrodes. Conversely, in an AC PDP, a dielectric layer covers at least one electrode, and discharge is performed by wall charges instead of charges that directly move between electrodes.

PDPs may also be facing discharge PDPs or surface discharge PDPs according to electrode arrangement. A facing discharge PDP has a pair of sustain electrodes that are respectively formed on an upper substrate and a lower substrate, and discharge occurs perpendicular to the substrates. On the other hand, a surface discharge PDP has a pair of sustain electrodes that are formed on the same substrate, and discharge occurs parallel to the substrate. Although a facing discharge PDP has high luminous efficiency, plasma may easily deteriorate its florescent layer. Hence, surface discharge PDPs are typically used.

FIG. 1 is an exploded perspective view of a conventional surface discharge PDP, and FIG. 2 is a cross-sectional view of the PDP of FIG. 1. The upper substrate of FIG. 2 is rotated 90° so that an inner structure of the PDP may be better understood. Referring to FIG. 1 and FIG. 2, the conventional PDP includes a lower substrate 10 and an upper substrate 20 facing each other and separated by a predetermined distance. Plasma discharge occurs in the discharge space between the lower substrate 10 and the upper substrate 20.

A plurality of address electrodes 11 are formed on the upper surface of the lower substrate 10, and a first dielectric layer 12 covers the address electrodes 11. A plurality of barrier ribs 13, which are formed at predetermined intervals, partition the discharge space into a plurality of discharge cells 14 and prevent electrical and optical cross-talk between adjacent discharge cells 14. A discharge gas, which is usually a mixture of Ne gas and Xe gas, fills the discharge cells 14, and a fluorescent layer 15 is coated to a predetermined thickness on the first dielectric layer 12 and sides of the barrier ribs 13, which form the walls of the discharge cells 14.

The upper substrate 20, which is transparent and usually formed of glass, is coupled to the lower substrate 10. Pairs of sustain electrodes 21a and 21b, which are arranged perpendicular to the address electrodes 11, are formed on the upper substrate 20. The sustain electrodes 21a and 21b are formed of a transparent conductive material, such as indium tin oxide (ITO), so that they may transmit visible light. Bus electrodes 22a and 22b, which are narrower than the sustain electrodes 21a and 21b, are formed on the sustain electrodes 21a and 21b, respectively, to reduce the sustain electrodes' line resistance. A transparent second dielectric layer 23 covers the sustain electrodes 21a and 21b and the bus electrodes 22a and 22b, and a protective layer 24 covers the second dielectric layer 23. The protective layer 24 prevents plasma sputtering from damaging the second dielectric layer 23, and it emits secondary electrons, thereby lowering a discharge voltage. The protective layer 24 is generally formed of magnesium oxide (MgO).

The operation of a PDP constructed as above may be mainly divided into an address discharge operation and a sustain discharge operation. The address discharge occurs between an address electrode and one of the sustain electrodes 21a and 21b, and it forms wall charges on the second dielectric layer 23. Sustain discharge occurs between the sustain electrodes 21a and 21b in the discharge cells 14 in which wall charges are formed. During sustain discharge, the fluorescent layer 15 of the corresponding discharge cell 14 is excited by UV rays and emits visible light. The visible light emits through the upper substrate 20 and forms a recognizable image. However, when addressing using wall charges formed by the above-described address discharge, unnecessary time is consumed and power is wasted. A method of shortening a pulse, which induces addressing, and extending a sustain discharge period to solve this problem may be unstable, and it may also increase a discharge voltage.

### SUMMARY OF THE INVENTION

This invention provides a PDP including electron emission sources that have an addressing function, which may reduce unnecessary time and power consumption, and a method of driving the PDP.

Additional features of the invention will be set forth in the description which follows, and in part will be apparent from the description, or may be learned by practice of the invention.

The present invention discloses a PDP including a lower substrate and an upper substrate facing each other with a discharge space therebetween and a plurality of barrier ribs partitioning the discharge space and defining a plurality of discharge cells. A pair of first and second sustain electrodes corresponds to each discharge cell, and an electron emission source corresponds to each discharge cell. The electron emission source emits electrons into the discharge cells to address the discharge cells and simultaneously cause a sustain discharge between the first and second sustain electrodes. A florescent layer is coated on inner walls of the discharge cells.

The present invention also discloses a method of driving a PDP including a first sustain electrode, a second sustain electrode, and an electron emission source corresponding to a discharge cell. The method includes applying a voltage between the first sustain electrode and the second sustain electrode, and addressing the discharge cell and simultaneously causing a sustain discharge between the first and second sustain electrodes while applying the voltage between the first and second sustain electrodes by supplying an electron emission pulse to the discharge cell from the electron emission source.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view showing a conventional surface discharge PDP.

FIG. 2 is a cross-sectional view showing the PDP of FIG. 1.

FIG. 3 is a cross-sectional view showing a PDP according to a first exemplary embodiment of the present invention.

FIG. 4 is a plan view showing an electrode arrangement of the PDP of FIG. 3.

FIG. 5 is a timing diagram for explaining a method of driving the PDP of FIG. 3.

FIG. 6 is a cross-sectional view showing a PDP according to a second exemplary embodiment of the present invention.

FIG. 7 is a cross-sectional view showing a PDP according to a third exemplary embodiment of the present invention.

FIG. 8 is a cross-sectional view showing a PDP according to a fourth exemplary embodiment of the present invention.

FIG. 9 is a cross-sectional view showing a PDP according to a fifth exemplary embodiment of the present invention.

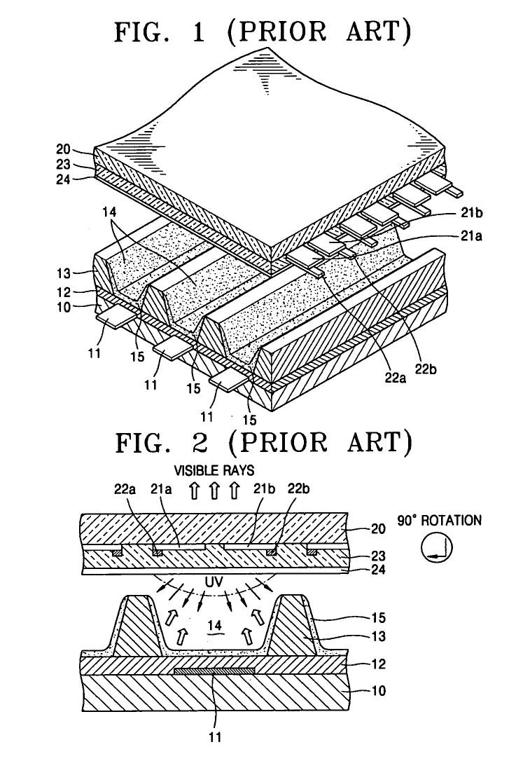

### DETAILED DESCRIPTION OF THE ILLUSTRATED EMBODIMENTS

The present invention will now be described more fully with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

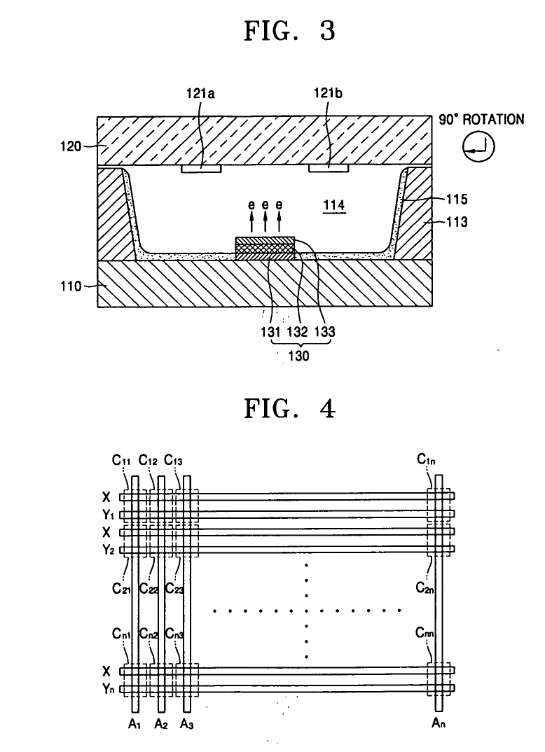

FIG. 3 is a cross-sectional view showing a PDP according to a first exemplary embodiment of the present invention. In FIG. 3, the upper substrate 120 is rotated 90° so that the inner structure of the PDP may be better understood.

Referring to FIG. 3, a lower substrate 110 and the upper substrate 120 face each other with a discharge space therebetween. The lower substrate 110 and the upper substrate 120 may be glass substrates. A plurality of barrier ribs 113 are arranged between the lower substrate 110 and the upper substrate 120, and they partition the discharge space to define a plurality of discharge cells 114 and prevent electrical and optical cross-talk between adjacent discharge cells 114. A discharge gas, which emits UV rays through plasma discharge, fills the discharge cells 114. Additionally, florescent layers 115, which emit red, green, or blue light, are coated on inner walls of the discharge cells 114. The florescent layers 115 are excited by the UV rays emitted through plasma discharge, and thus emit visible light with a predetermined color.

A pair of first and second sustain electrodes 121a and 121b are arranged parallel to each other on the upper substrate 120 in each discharge cell 114. The first and second sustain electrodes 121a and 121b may serve as a display electrode and a scanning electrode, respectively. The first and second sustain electrodes 121a and 121b may be made of transparent conductive materials, such as indium tin oxide (ITO).

Electron emission sources 130 are arranged on the lower substrate 110 in each discharge cell 114, and they extend perpendicularly to the first and second sustain electrodes 121a and 121b. The electron emission sources 130 emit electrons into the discharge cells 114, thereby addressing the discharge cells 114 and simultaneously causing a sustain discharge between the first and second sustain electrodes 121a and 121b. Each electron emission source 130 may include a base electrode 131 arranged on the lower substrate 110, an electron accelerating layer 132 arranged on the base electrode 131, and an emitter electrode 133 arranged on the electron accelerating layer 132. The base electrode 131 and the emitter electrode 133 serve as cathode and anode, respectively. Electrons emitted from the base electrode 131 accelerate in the electron accelerating layer 132, due to a predetermined voltage applied between the base electrode 131 and the emitter electrode 133, and then are emitted into the discharge cells 114 via the emitter electrode 133. The electron accelerating layer 132 may be made of oxidized porous silicon or carbon nanotubes (CNTs). The oxidized porous silicon may be oxidized porous polycrystalline silicon (polysilicon) or oxidized porous amorphous silicon.

In such a PDP, a predetermined voltage (e.g., 140 V) is applied between the first sustain electrode 121a and the second sustain electrode 121b. The predetermined voltage is slightly lower than a voltage (e.g., 180 V) at which sustain discharge may occur between the first sustain electrode 121a and the second sustain electrode 121b without electrons being emitted into the discharge cells 114. While applying the predetermined voltage between the first sustain electrode 121a and the second sustain electrode 121b as described above, the electron emission sources 130 may emit electrons into the discharge cells 114. More specifically, electrons accelerate as they pass through the electron accelerating layer 132 as a voltage is applied between the base electrode 131 and the emitter electrode 133, and thus the electrons are emitted into the discharge cells 114. The electrons emitted into the discharge cells 114 lower the discharge voltage, and accordingly, sustain discharge may occur between the first and second sustain electrodes 121a and 121b. Consequently, emitting electrons into the discharge cells 114 addresses the discharge cells 114 and simultaneously generates sustain discharge between the first and second sustain electrodes 121a and 121b.

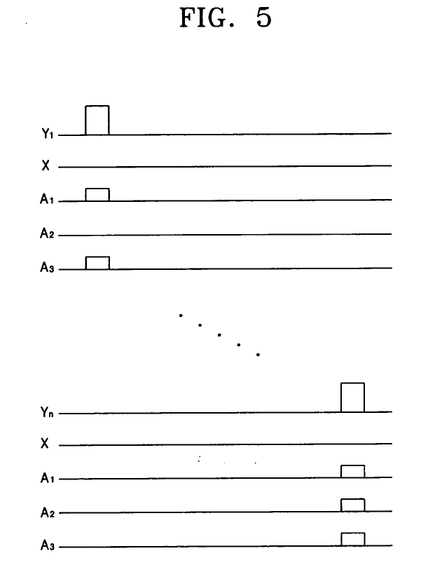

FIG. 4 is a schematic plan view showing an arrangement of the first and second sustain electrodes 121a and 121b and the electron emission sources 130 in the PDP of FIG. 3, and FIG. 5 is a timing diagram for explaining a method of driving the PDP of FIG. 3. In FIG. 4 and FIG. 5, X denotes display electrodes, which are the first sustain electrodes 121a, and Y₁, Y₂, . . . , and Yₙ denote scanning electrodes, which are the second sustain electrodes 121b. Additionally, A₁, A₂, A₃, . . . , and Aₙ denote the electron emission sources 130, and C₁₁, C₁₂, C₁₃, . . . , and C₁ₙ; C₂₁, C₂₂, C₂₃, . . . , and, C₂ₙ; and Cₙ₁, Cₙ₂, Cₙ₃, . . . , and Cₙₙ denote the discharge cells 114.

Referring to FIG. 4 and FIG. 5, first, a predetermined voltage is applied to the scanning electrode Y₁, but not to any of the other scanning electrodes Y₂, . . . and Yₙ. The predetermined voltage is slightly lower than the voltage at which sustain discharge may occur between the scanning electrode Y₁ and the corresponding X electrode without electrons being emitted into the discharge cells 114 from the electron emission source 130. When an electron emission pulse is applied to, for example, the discharge cells C₁₁ and C₁₃ via the electron emission sources A₁ and A₃ while the predetermined voltage is applied to the scanning electrode Y₁, the discharge cells C₁₁ and C₁₃ are simultaneously addressed and sustain discharged.

Next, a predetermined voltage is applied to the scanning electrode Y₂, but not to any of the other scanning electrodes Y₁, Y₃, . . . and Yₙ. The predetermined voltage, which is slightly lower than the voltage at which sustain discharge may occur, is applied to the scanning electrode Y₂ regardless of whether the electron emission sources 130 emit electrons into the discharge cells 114 that correspond to the scanning electrode Y₂, as described above. In this state, electrons are emitted from a selected electron emission source 130, thereby addressing the discharge cells 114 and generating a sustain discharge in the discharge cells.

These processes repeat for the remaining scanning electrodes (i.e. scanning electrodes Y₃ through Yₙ).

The brightness of the visible light emitted from each discharge cell through the above described processes may be adjusted by controlling the period or amplitude of the electron emission pulse.

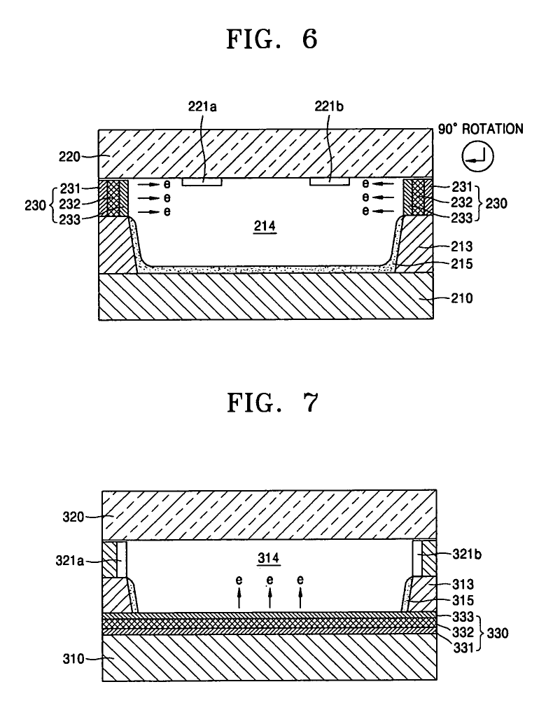

FIG. 6 is a cross-sectional view showing a PDP according to a second exemplary embodiment of the present invention. In FIG. 6, the upper substrate 220 is rotated 90° so that the inner structure of the PDP may be better understood.

Referring to FIG. 6, a lower substrate 210 and the upper substrate 220 face each other with a discharge space therebetween, and a plurality of barrier ribs 213, which partition the discharge space and define a plurality of discharge cells 214, are arranged between the first and second substrates 210 and 220. A discharge gas fills the discharge cells 214, and florescent layers 215 are coated on inner walls of the discharge cells 214. A pair of first and second sustain electrodes 221a and 221b are arranged parallel to each other on the upper substrate 220 and correspond to the discharge cells 214.

Electron emission sources 230 are arranged between the upper substrate 220 and the barrier ribs 213, and they extend perpendicularly to the first and second sustain electrodes 221a and 221b. The electron emission sources 230 emit electrons into the discharge cells 214, as described in the first exemplary embodiment, thereby addressing the discharge cells 214 and simultaneously causing a sustain discharge between the first and second sustain electrodes 221a and 221b. Each electron emission source 230 may include a base electrode 231 and an emitter electrode 233 arranged on the barrier rib 213 to face each other, and an electron accelerating layer 232 arranged between the base electrode 231 and the emitter electrode 233. Here, the base electrode 231 and the emitter electrode 233 may serve as cathode and anode, respectively. Electrons emitted from the base electrode 231 accelerate in the electron accelerating layer 232, due to a predetermined voltage applied between the base electrode 231 and the emitter electrode 233, and then are emitted into the discharge cells 214 via the emitter electrode 233. The electron accelerating layer 232 may be made of oxidized porous silicon or CNTs. The oxidized porous silicon may be oxidized porous polysilicon or oxidized porous amorphous silicon. The operation of the PDP of the present exemplary embodiment will not be described here since it is the same as that of the first exemplary embodiment.

FIG. 7 is a cross-sectional view showing a PDP according to a third exemplary embodiment of the present invention.

Referring to FIG. 7, a lower substrate 310 and an upper substrate 320 face each other with a discharge space therebetween, and a plurality of barrier ribs 313, which partition the discharge space and define a plurality of discharge cells 314, are arranged between the first and second substrates 310 and 320. A discharge gas fills the discharge cells 314, and florescent layers 315 are coated on inner walls of the discharge cells 314.

Pairs of first and second sustain electrodes 321a and 321b are arranged parallel to each other and between the upper substrate 320 and adjacent barrier ribs 313. Also, an electron emission source 330 is arranged perpendicularly to the first and second sustain electrodes 321a and 321b and on the lower substrate 310 in the discharge cells 314. The electron emission sources 330 emit electrons into the discharge cells 314, thereby addressing the discharge cells 314 and simultaneously causing a sustain discharge between the first and second sustain electrodes 321a and 321b. Each electron emission source 330 may include a base electrode 331 arranged on the lower substrate 310, an electron accelerating layer 332 arranged on the base electrode 331, and an emitter electrode 333 arranged on the electron accelerating layer 332. Here, the base electrode 331 and the emitter electrode 333 may serve as cathode and anode, respectively. Electrons emitted from the base electrode 331 accelerate in the electron accelerating layer 332, due to a predetermined voltage applied between the base electrode 331 and the emitter electrode 333, and then are emitted into the discharge cells 314 via the emitter electrode 333. The electron accelerating layer 332 may be made of oxidized porous silicon or CNTs. The oxidized porous silicon may be oxidized porous polysilicon or oxidized porous amorphous silicon. The operation of the PDP of the present exemplary embodiment will not be described here since it is the same as that of the first exemplary embodiment.

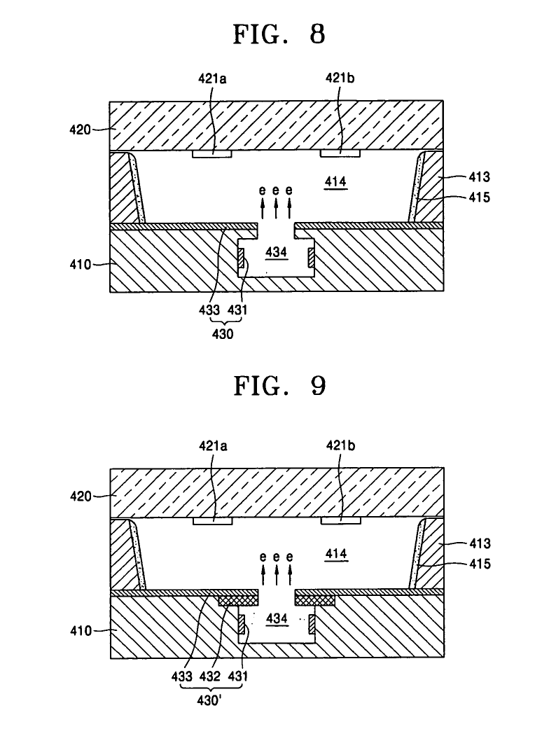

FIG. 8 is a cross-sectional view showing a PDP according to a fourth exemplary embodiment of the present invention.

Referring to FIG. 8, a lower substrate 410 and an upper substrate 420 face each other with a discharge space therebetween, and a plurality of barrier ribs 413, which partition the discharge space and define a plurality of discharge cells 414, are arranged between the first and second substrates 410 and 420. A discharge gas fills the discharge cells 414, and florescent layers 415 are coated on inner walls of the discharge cells 414. A pair of first and second sustain electrodes 421a and 421b are arranged parallel to each other on the upper substrate 420 and correspond to the discharge cells 414.

An electron emission source 430, which emits electrons into the discharge cells 414, is arranged in the discharge cells 414 perpendicularly to the first and second sustain electrodes 421a and 421b. The electron emission sources 430 emit electrons into the discharge cells 414 as described above, thereby addressing the discharge cells 414 and simultaneously causing a sustain discharge between the first and second sustain electrodes 421a and 421b. Each electron emission source 430 may include a chamber 434 formed in the lower substrate 410 and connected with the discharge cell 414, a base electrode 431 arranged on inner walls of the chamber 434, and an emitter electrode 433 arranged on the lower substrate 410. The base electrode 431 and the emitter electrode 433 may serve as cathode and anode, respectively. A through-hole is formed in the emitter electrode 433 to connect the discharge cell 414 and the chamber 434 so that electrons may be emitted from the chamber 434 into the discharge cell 414 via the through-hole. Electrons emit from the base electrode 431 inside the chamber 434 when a predetermined voltage is applied between the base electrode 431 and the emitter electrode 433. Then, the electrons emit from the chamber 434 into the discharge cells 414 via the through-hole of the emitter electrode 433 due to the electric field formed between the base electrode 431 and the emitter electrode 433. Electrons emitted into the discharge cells 414 in this way address the discharge cell 414 and simultaneously cause a sustain discharge between the first and second sustain electrodes 421a and 421b. The operation of the PDP of the present exemplary embodiment is the same as that of the first exemplary embodiment, and therefore will not be described here.

FIG. 9 is a cross-sectional view showing a PDP according to a fifth exemplary embodiment of the present invention. The following description will mainly describe the difference between the PDP of the fifth exemplary embodiment and the PDP of the fourth exemplary embodiment shown in FIG. 8.

Referring to FIG. 9, electron emission sources 430′, which emit electrons into discharge cells 414, are arranged in the discharge cells 414. Each electron emission source 430′ may include a chamber 434 formed in a lower substrate 410 and connected with the discharge cell 414, a base electrode 431 arranged on inner walls of the chamber 434, an emitter electrode 433 arranged on the lower substrate 410, and an electron accelerating layer 432 arranged between the emitter electrode 433 and the lower substrate 410. Electrons emitted from the base electrode 431 accelerate in the electron accelerating layer 432, due to a predetermined voltage applied between the base electrode 431 and the emitter electrode 433, and then are emitted into the discharge cells 414 via the emitter electrode 433. The electron accelerating layer 432 may be made of oxidized porous silicon or CNTs. The oxidized porous silicon may be oxidized porous polysilicon or oxidized porous amorphous silicon. Electrons emitted into the discharge cell 414 by the electron emission source 430′ address the discharge cell 414 and simultaneously cause a sustain discharge between first and second sustain electrodes 421a and 421b.

In a PDP according to exemplary embodiments of the present invention, by including electron discharge sources, which emit electrons into discharge cells, addressing and sustain discharge may be simultaneously performed. Consequently, unnecessary time and power consumption, which are problems for a conventional PDP, may be prevented.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel (PDP), comprising:
a lower substrate and an upper substrate facing each other with a discharge space therebetween;
a plurality of barrier ribs partitioning the discharge space into a plurality of discharge cells;
first sustain electrodes and second sustain electrodes corresponding to the discharge cells;
electron emission sources corresponding to the discharge cells, and that emit electrons into the discharge cells to address the discharge cells and simultaneously cause a sustain discharge between the first sustain electrodes and the second sustain electrodes; and
a florescent layer arranged in the discharge cells.

2. The PDP of claim 1, wherein the first sustain electrodes and the second sustain electrodes are arranged on the upper substrate, and the electron emission sources are arranged perpendicular to the first sustain electrodes and the second sustain electrodes and on the lower substrate.

3. The PDP of claim 2, wherein the electron emission sources comprise:
a base electrode and an emitter electrode, the electrons being emitted into the discharge cells via the emitter electrode; and
an electron accelerating layer in which electrons emitted from the base electrode are accelerated when a voltage is applied between the base electrode and the emitter electrode, the electron accelerating layer being arranged between the base electrode and the emitter electrode.

4. The PDP of claim 3, wherein the electron accelerating layer comprises oxidized porous silicon or carbon nanotubes.

5. The PDP of claim 4, wherein the oxidized porous silicon comprises oxidized porous polycrystalline silicon or oxidized porous amorphous silicon.

6. The PDP of claim 1, wherein the first sustain electrodes and the second sustain electrodes are arranged on the upper substrate, and the electron emission sources are arranged perpendicular to the first sustain electrodes and the second sustain electrodes and between the upper substrate and the barrier ribs.

7. The PDP of claim 6, wherein the electron emission sources comprise:
a base electrode and an emitter electrode, the electrons being emitted into the discharge cells via the emitter electrode; and
an electron accelerating layer in which electrons emitted from the base electrode are accelerated when a voltage is applied between the base electrode and the emitter electrode, the electron accelerating layer being arranged between the base electrode and the emitter electrode.

8. The PDP of claim 7, wherein the electron accelerating layer comprises oxidized porous silicon or carbon nanotubes.

9. The PDP of claim 8, wherein the oxidized porous silicon comprises oxidized porous polycrystalline silicon or oxidized porous amorphous silicon.

10. The PDP of claim 1, wherein the first sustain electrodes and the second sustain electrodes are respectively arranged between the upper substrate and the barrier ribs, and the electron emission sources are arranged perpendicular to the first sustain electrodes and the second sustain electrodes and on the lower substrate.

11. The PDP of claim 10, wherein the electron emission sources comprise:
a base electrode and an emitter electrode, the electrons being emitted into the discharge cells via the emitter electrode; and
an electron accelerating layer in which electrons emitted from the base electrode are accelerated when a voltage is applied between the base electrode and the emitter electrode, the electron accelerating layer being arranged between the base electrode and the emitter electrode.

12. The PDP of claim 11, wherein the electron accelerating layer comprises oxidized porous silicon or carbon nanotubes.

13. The PDP of claim 12, wherein the oxidized porous silicon comprises oxidized porous polycrystalline silicon or oxidized porous amorphous silicon.

14. The PDP of claim 1, wherein the electron emission sources comprise:
a chamber arranged in the lower substrate and communicating with a corresponding discharge cell;
a base electrode arranged on a wall of the chamber; and
an emitter electrode arranged on the lower substrate.

15. The PDP of claim 14, wherein the emitter electrode comprises a through-hole so that electrons emitted due a voltage applied between the base electrode and the emitter electrode are emitted from the chamber into the corresponding discharge cell.

16. The PDP of claim 15, wherein the electron emission source further comprises an electron accelerating layer, the emitter electrode being arranged on the electron accelerating layer.

17. The PDP of claim 16, wherein the electron accelerating layer comprises oxidized porous silicon or carbon nanotubes.

18. The PDP of claim 17, wherein the oxidized porous silicon comprises oxidized porous polycrystalline silicon or oxidized porous amorphous silicon.

19. A method of driving a plasma display panel comprising a first sustain electrode, a second sustain electrode, and an electron emission source corresponding to a discharge cell, the method comprising:
applying a voltage between the first sustain electrode and the second sustain electrode; and
addressing the discharge cell and simultaneously causing a sustain discharge between the first sustain electrode and the second sustain electrode while applying the voltage between the first sustain electrode and the second sustain electrode by supplying an electron emission pulse to the discharge cell from the electron emission source.

20. The method of claim 19, wherein the voltage applied between the first sustain electrode and the second sustain electrode is less than a voltage at which a sustain discharge can occur between the first sustain electrode and the second sustain electrode.

21. The method of claim 19, further comprising:
sequentially applying the voltage between a plurality of first sustain electrodes and second sustain electrodes.

22. The method of claim 19, further comprising:
controlling the brightness of visible light emitted from the discharge cell by the period of the electron emission pulse.

23. The method of claim 19, further comprising:
controlling the brightness of visible light emitted from the discharge cell by the amplitude of the electron emission pulse.
